(19) United States
(12) Patent Application Publication
(10) Pub. No.: US 2010/0161974 A1
(43) Pub. Date: Jun. 24, 2010

(54) MASTER TERMINAL CAPABLE OF REGISTERING AND MANAGING TERMINALS OF PERSONAL USE SCOPE, AND METHOD AND SYSTEM USING THE SAME

(76) Inventors: Jooyoung LEE, Seoul (KR); Hyon-Gon CHOO, Daejon (KR); Jeho NAM, Seoul (KR); Moon-Kyun OH, Daejon (KR); Sang-Kwon SHIN, Daejon (KR); Won-Sik CHEONG, Daejon (KR); Sangwoo AHN, Daejon (KR); Jin-Woo HONG, Daejon (KR); Byoung-Soo KOH, Gyeonggi-do (KR)

Correspondence Address: LADAS & PARRY LLP, 224 SOUTH MICHIGAN AVENUE, SUITE 1600, CHICAGO, IL, 60604, US

(21) Appl. No.: 12/578,688

(22) Filed: Oct. 14, 2009

(30) Foreign Application Priority Data
Dec. 19, 2008 (KR) 10-2008-0130465

(51) Int. Cl. H04L 29/06; G06F 15/16; H04L 9/08

(52) U.S. Cl. 713/162; 709/208; 380/279; 709/225

(57) ABSTRACT

Disclosed are a master terminal capable of registering and managing terminals that belong to a personal use scope, which will be referred to as personally used terminals or personal use terminals, hereafter, and a method and system for managing personal use terminals by using the master terminal. The method for managing a personal use group using a first master terminal to register and manage terminals belonging to a personal use scope includes: requesting a second master terminal that belongs to the personal use scope for personal use group information; receiving the personal use group information from the second master terminal; and registering a terminal that belongs to the personal use scope as the personal use group based on the received personal use group information.

### CROSS-REFERENCE TO RELATED APPLICATIONS

The present invention claims priority of Korean Patent Application No. 10-2008-0130465, filed on Dec. 19, 2008, which is incorporated herein by reference.

### BACKGROUND OF THE INVENTION

1. Field of the Invention

The present invention relates to a master terminal capable of registering and managing terminals that belong to a personal use scope, which will be referred to as personally used terminals or personal use terminals, hereafter, and a method and system for managing personal use terminals by using the master terminal.

2. Description of Related Art

Digital contents are data and information obtained by processing and producing codes, text, speech, sound, image, and video through a digital method. Digital contents include video-audio contents, such as drama and movie, and video games. The forms and range of digital contents continue to expand.

Digital contents are easily and quickly copied, and since the copied one maintains the same quality as the original one, it can be readily distributed through a wired or wireless electric communication network. This causes a problem that digital contents are illegally copied and distributed without going through a lawful distribution process.

To cope with this problem, Digital Rights Management (DRM) technology was suggested to protect digital contents from being copied and distributed without permission and lawfully distribute the digital contents through user authorization and charging procedure.

However, the initial DRM technology prevented the illegal copying of digital contents on a single device basis. Thus, although a user receives a digital content through a lawful distribution path, the user can use the digital content only in the terminal used for receiving the digital content. In other words, the user cannot use the digital content in other devices that the user owns. Here, a problem that the personal use right by a lawful user is infringed.

For example, when a user pays a predetermined amount of money and downloads a digital content into his personal computer (PC), he is not allowed to copy and transmit the digital content to his Portable Multimedia Player (PMP). Although the user has a lawful right of using the digital content, he cannot freely use the digital content within the scope the user can use it personally, which will be referred to as a personal use scope hereafter, and this is a problem.

To protect the right of a user personally using a digital content, conventional technology called domain technology was suggested. Domain technology allows a user to register a plurality of devices that belong to the personal use scope of the user, which are terminals owned by the user, in a domain and share a digital content among the registered terminals.

The domain technology has two ways of registering devices. First, terminals that belong to a personal use scope are registered as a group in a domain registration and management server and the domain registration and management server assigns a domain for each group. Second, a master function is given to any one terminal, which will be referred to as a master terminal, among the multiple terminals that belong to a personal use scope and the master terminal registers the other terminals of the personal use scope.

Since the domain technology is developed to secure the use of a digital content within the personal use scope of a user, it is desirable to use a master terminal to secure the use right of the user.

Hereafter, domain technology for registering terminals of a personal use scope through a master terminal will be described in detail with reference to the drawings.

FIG. 1 illustrates a typical domain technology. Particularly, the drawing describes a domain technology for registering and managing terminals that belong to a personal use scope by using a master terminal.

As illustrated, a plurality of terminals 110, 111, 112, 113, 120, 121, 122 and 123 may be included in a personal use scope (A), and they may be registered as a group allowed to share a digital content, which is called a domain B1 or B2, through a master terminal 110 or 120 given with a master function. For example, the terminals 111, 112 and 113 may be registered in a first domain B1 through a first master terminal 110, whereas the terminals 121, 122 and 123 may be registered in a second domain B2 through a second master terminal 120.

Herein, each domain B1 or B2 is assigned with a domain identifier, and the terminals 110, 111, 112 and 113, or 120, 121, 122 and 123 registered to the domain B1 or B2 share a domain key. A domain key is an encryption key shared by the terminals that belong to a domain B1 or B2. For instance, the terminals 110, 111, 112 and 113 registered to the domain B1 share a first domain key, whereas the terminals 120, 121, 122 and 123 registered to the domain B2 share a second domain key.

Therefore, the terminals that belong to the domain B1 or B2 transmit/receive a digital content encrypted using a scrambling key, a scrambling key encrypted using a domain key, and encryption information. They share the digital content by decrypting the encrypted scrambling key using the domain key to thereby acquire the scrambling key, and decrypting the encrypted digital content and encryption information using the acquired scrambling key.

For example, when the terminals 110, 111, 112 and 113 of the first domain B1 share the digital content and the encryption information which are encrypted using the first domain key, the terminals 110, 111, 112 and 113 can freely copy the digital content and transmit/receive to/from each other. However, even though the terminals 120, 121, 122 and 123 of the second domain B2 receive the digital content and the encryption information, they cannot decode the digital content and the encryption information because they do not have the first domain key.

Meanwhile, when there are a plurality of master terminals 110 and 120 within a personal use scope (A), the terminals 111, 112, 113, 121, 122 and 123 are registered in a domain B1 or B2 through one master terminal 110 or 120. Accordingly, the terminals 111, 112 and 113, or 121, 122 and 123 registered through the same master terminal 110 or 120 form one domain B1 or B2 along with the master terminal 110 or 120. In this way, more than one domain B1 and B2 may be formed within a personal use scope (A).

When a plurality of domains B1 and B2 are formed within a personal use scope, each terminal is given with a domain identifier and a domain key according to the domain B1 or B2 to which the terminal belongs. Therefore, the user goes through a trouble of managing multiple domains.

In particular, the terminals 111, 112 and 113, or 121, 122 and 123 that belong to each domain B1 or B2 should be managed separately. Although a terminal belongs to the same personal use scope (A), it is allowed or not allowed to share the digital content according to the domain B1 or B2 it belongs to.

For example, although a third terminal 111 and a sixth terminal 121 all belong to the same personal use scope (A), the third terminal 111 belongs to the domain B1 and the sixth terminal 121 belongs to the domain B2. Because they belong to different domains, they have a different domain key. Even though the sixth terminal 121 requests the third terminal 111 to send a digital content and receives the digital content, it cannot decode the digital content because it has a different domain key. In short, the digital content cannot be shared between the third terminal 111 and the sixth terminal 121.

Also, since the first domain B1 is managed by a first master terminal 110, the first master terminal 110 should be in operation all the time. However, the first master terminal 110 may not operate sometimes due to a reason such as malfunction in an actual environment. During the time the first master terminal 110 does not operate, it is impossible to register other terminals in the first domain B1 and this is a problem.

To solve the problem, it is required to develop a technology that can register terminals in a domain through a plurality of master terminals that belong to the personal use scope (A) and conveniently manage a plurality of domains.

### SUMMARY OF THE INVENTION

An embodiment of the present invention devised to satisfy the above need is directed to provide a master terminal capable of registering and managing terminals that belong to a personal use scope, and a method and system for managing a personal use group by using the master terminal.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an aspect of the present invention, there is provided a method for managing a personal use group using a first master terminal to register and manage terminals belonging to a personal use scope, including: requesting a second master terminal that belongs to the personal use scope for personal use group information; receiving the personal use group information from the second master terminal; and registering a terminal that belongs to the personal use scope as the personal use group based on the received personal use group information.

In accordance with another aspect of the present invention, there is provided a first master terminal for registering and managing terminals belonging to a personal use scope, including: a storage configured to store personal use group information; a personal use group information management unit configured to share the personal use group information with a second master terminal; and a registration unit configured to register a terminal that belongs to the personal use scope in a personal use group based on the personal use group information.

In accordance with another aspect of the present invention, there is provided a personal use group management system for registering and managing a plurality of terminals belonging to a personal use scope, including: a plurality of master terminals configured to share personal use group information, and register the terminals that belong to the personal use scope in a personal use group based on the shared personal use group information; and the terminals configured to be registered in the personal use group through any one of the master terminals and share a digital content.

### BRIEF DESCRIPTION OF THE DRAWINGS

FIG. 1 is a block diagram illustrating a typical domain technology.

FIG. 2 is a block diagram illustrating a network configuration of a personal use group management system for registering and managing terminals that belong to a personal use scope in accordance with an embodiment of the present invention.

FIG. 3 illustrating a configuration of a master terminal for registering and managing terminals that belong to a personal use scope in accordance with an embodiment of the present invention.

FIG. 4 is a flowchart describing a personal use group management method in accordance with an embodiment of the present invention.

FIG. 5 is a flowchart describing a personal use group management method in detail in accordance with an embodiment of the present invention.

### DESCRIPTION OF SPECIFIC EMBODIMENTS

The advantages, features and aspects of the invention will become apparent from the following description of the embodiments with reference to the accompanying drawings, which is set forth hereinafter. When it is considered that detailed description on a prior art may obscure a point of the present invention, the description will not be provided herein. Hereafter, embodiments of the present invention will be described in detail with reference to the accompanying drawings.

The technology of the present invention registers terminals that belong to a personal use scope to a personal use group and manages the terminals in the personal use group by using a master terminal to have the terminals of the personal use group share digital contents. In particular, as personal use group information is shared among a plurality of master terminals that belong to the same personal use scope, it becomes possible to conveniently register and manage the personal use group.

In this patent specification, “personal use scope” signifies a scope of terminals that are owned by the same user or terminals considered to have an authority to share a digital content even if the owner may be different. Terminals of the same personal use scope are allowed to share a digital content. In other words, a scope of terminals owned by a user or a scope of predetermined terminals authenticated to use a digital content are regarded to belong to the personal use scope.

Also, in this patent specification, a “personal use group” signifies a group of terminals registered through a predetermined master terminal among terminals that belong to a personal use scope. A personal use group is assigned with an identifier, and the terminals of the same personal use group share the same group encryption key. For instance, when a personal use group is registered and managed based on a conventional domain technology, a domain identifier is assigned to each personal use group, and the terminals of the same personal use group share a domain key.

Although this patent specification describes a master terminal and terminal separately, this is only for convenience in explanation and a master function may be given to any one terminal of a plurality of terminals that belong to a personal use scope and the terminal with the master function may serve as a master terminal.

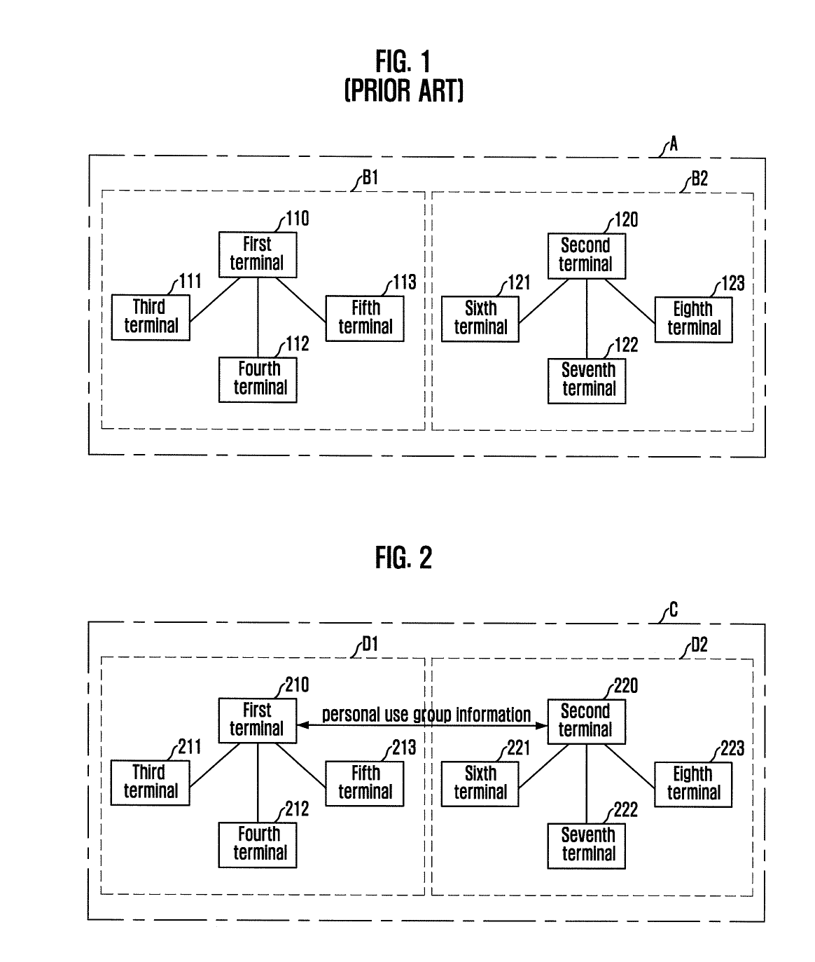

FIG. 2 is a block diagram illustrating a network configuration of a personal use group management system for registering and managing terminals that belong to a personal use scope in accordance with an embodiment of the present invention. Hereafter, a process of registering a first personal use group D1 through a first master terminal 210 and registering a second personal use group D2 through a second master terminal 220 among terminals of a personal use scope (C) will be described.

As illustrated, the personal use group management system includes a plurality of mater terminals 210 and 220 and a plurality of terminals 211, 212, 213, 221, 222 and 223. The mater terminals 210 and 220 share personal use group information and register terminals that belong to a personal use scope (C) in a personal use group D1 or D2. The terminals 211, 212 and 213, or 221, 222 and 223 are registered in the personal use group D1 or D2 through the master terminal 210 or 220.

The master terminal 210 or 220 registers terminals in a personal use group D1 or D2, stores and manages personal use group information, and shares the personal use group information with the other master terminal 220 or 210.

For example, it is assumed that a first master terminal 210 shares personal use group information with a second master terminal 220. First, a first personal use group D1 and a second personal use group D2 may have the same group identifier and a group encryption key. In this case, the first personal use group D1 and the second personal use group D2 may be managed as one group substantially. Second, the first personal use group D1 and the second personal use group D2 may have different group identifiers but share a group encryption key. In this case, the first personal use group D1 and the second personal use group D2 are managed as different group, but since they share the same group encryption key, they can share a digital content.

The terminals 211, 212, 213, 221, 222 and 223 can transmit/receive and restore a digital content and they may be registered in the personal use groups D1 and D2 through the master terminals 210 and 220. Since the master terminals 210 and 220 share personal use group information between them, the terminals that belong to the same personal use group (C) come to have the same group encryption key although they are registered in different personal use groups D1 and D2 through different master terminals 210 and 220. Thus, they can share a digital content.

For instance, although a third terminal 211 is registered in the first personal use group D1 through the first master terminal 210 and a sixth terminal 221 is registered in the second personal use group D2 through the second master terminal 220, they can share a digital content because they share the same group encryption key.

According to an embodiment of the present invention, although there are the plurality of master terminals 210 and 220 in the same personal use scope, they can register terminals based on the same personal use group information, and the terminals 211, 212, 213, 221, 222 and 223 can share a digital content regardless of whether the master terminals D1 and D2 operate or not.

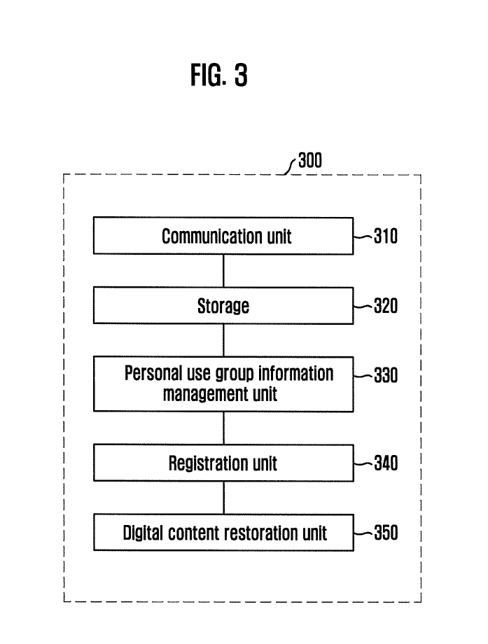

FIG. 3 illustrating a configuration of a master terminal for registering and managing terminals that belong to a personal use scope in accordance with an embodiment of the present invention.

As illustrated, a master terminal 300 includes a storage 320, a personal use group information management unit 330, and a registration unit 340. It may further include a communication unit 310 and a digital content restoration unit 350. The storage 320 stores personal use group information. The personal use group information management unit 330 shares the personal use group information with another master terminal. The registration unit 340 registers a terminal that belongs to a personal use scope in a personal use group based on the personal use group information. The communication unit 310 communicates with another terminal. The digital content restoration unit 350 decrypts and restores an encrypted digital content based on the personal use group information.

The communication unit 310 communicates with another master terminal based on diverse connection protocols, such as Universal Serial Bus (USB), Transport Control Protocol (TCP)/Internet Protocol (IP), Institute of Electrical and Electronics Engineers (IEEE) 1394, or Bluetooth, and transmits/receives the personal use group information.

The communication unit 310 may form a security channel between terminals while personal use group information is transmitted/received. Security channel may be formed using a variety of conventional security protocols, and the information security level of the security channel may be controlled diversely as well. A security channel may be a security session using a Diffie-Hellman (DH) algorithm or an authentic channel using a device authentication.

Also, the communication unit 310 communicates with another terminal or a predetermined server to transmit/receive a digital content. For example, it may communicate with a broadcasting station or a predetermined contents distribution server (not shown) to receive a digital content, or it may transmit/receive an encrypted digital content to/from the terminals of a personal use scope while communicating with them.

The storage 320 stores personal use group information. Personal use group information is information for encrypting and decrypting a digital content among the terminals of the personal use scope, and it includes at least identification information of a personal use group and a group encryption key shared by the personal use group.

The personal use group information management unit 330 shares personal use group information between master terminals. For examples, when another master terminal, which will be referred to as a second master terminal hereafter, requests to send personal use group information, the personal use group information management unit 330 decides whether the second master terminal is a terminal that belongs to the same personal use scope and whether to transmit the personal use group information to the second master terminal or not. Then, the personal use group information management unit 330 may transmit the personal use group information to the second master terminal through the communication unit 310. Also, the personal use group information management unit 330 may request the second master terminal for personal use group information and receive the personal use group information from the second master terminal.

The registration unit 340 registers terminals that belong to the personal use scope in a personal use group based on personal use group information. For example, the master terminal may directly search for a terminal of the personal use scope and register it in a personal use group, or it may receive a personal use group registration request from another terminal and register the requesting terminal in a personal use group.

The digital content restoration unit 350 decrypts and restores the encrypted digital content based on the personal use group information.

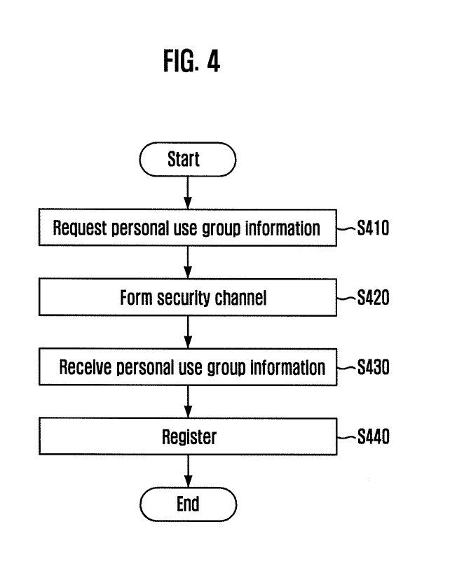

FIG. 4 is a flowchart describing a personal use group management method in accordance with an embodiment of the present invention. The details of the personal use group management method are as described with reference to FIGS. 2 and 3.

First, at step S410, the personal use group information management unit 330 requests another master terminal, which will be referred to as a second master terminal, of the personal use scope for personal use group information through the communication unit 310.

At step S420, a security channel is formed between the master terminal, which will be referred to as a first master terminal, and the second master terminal. At step S430, the first master terminal receives the personal use group information from the second master terminal through the communication unit 310, and stores the received personal use group information in the storage 320.

At step S440, a terminal that belongs to the personal use scope is registered in the personal use group through the communication unit 310.

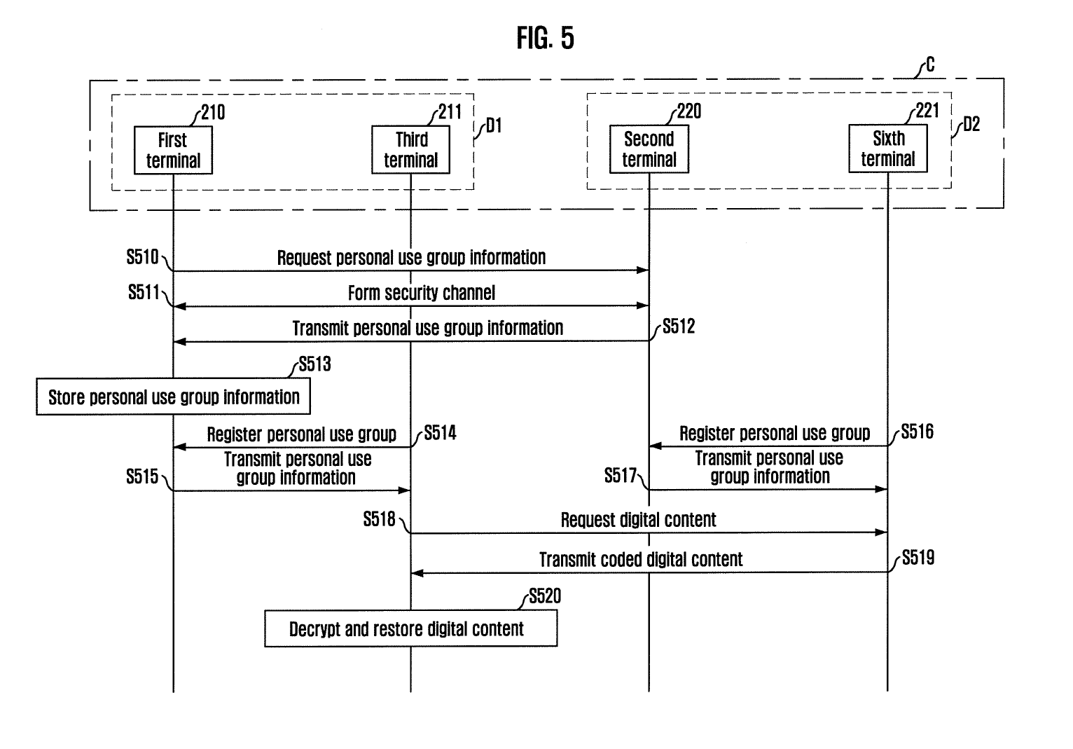

FIG. 5 is a flowchart describing a personal use group management method in detail in accordance with an embodiment of the present invention. The drawing particularly shows how information is exchanged between terminals. Details of the personal use group management method are as described with reference to FIGS. 2 and 3.

As illustrated, the first terminal 210, the third terminal 211, the second terminal 220, and the sixth terminal 221 belong to the same personal use scope, and the first terminal 210, which is the first master terminal, registers and manages the first personal use group D1, whereas the second terminal 220, which is the second master terminal, registers and manages the second personal use group D2.

First, at step S510, when the first master terminal 210 requests the second master terminal 220, which is another master terminal belonging to the same personal use scope, for personal use group information, the second master terminal 220 checks the personal use scope of the first master terminal 210 and decides whether to transmit the personal use group information.

At step S511, when the second master terminal 220 decides to transmit the personal use group information, a security channel is formed between the first master terminal 210 and the second master terminal 220. Upon the formation of the security channel, at step S512, the second master terminal 220 transmits the personal use group information to the first master terminal 210 through the communication unit 310. At step S513, the first master terminal 210 stores the received personal use group information in the storage 320. In this way, the first master terminal 210 and the second master terminal 220 come to share the personal use group information.

When the third terminal 211 is registered in the first personal use group through the first master terminal 210 at step S514, the first master terminal 210 transmits the personal use group information to the third terminal 211 at step S515. Also, when the sixth terminal 221 is registered in the second personal use group through the second master terminal 220 at step S516, the second master terminal 220 transmits the personal use group information to the sixth terminal 221 at step S517.

Here, the personal use group information that the third terminal 211 and the sixth terminal 221 receive may be different from the personal use group information shared between the first master terminal 210 and the second master terminal 220 in their structure, and they include at least a group encryption key. In this way, the third terminal 211 and the sixth terminal 221 can share the same group encryption key.

Subsequently, when the third terminal 211 requests the sixth terminal 221 for a digital content at step S518, the sixth terminal 221 transmits the digital content encrypted based on the group encryption key, and encryption information to the third terminal 211 at step S519.

At step S520, the third terminal 211 decrypts and restores the encrypted digital content transmitted from the sixth terminal 221 in the digital content restoration unit 350 by using the group encryption key.

The method of the present invention may be realized as a program and stored in a computer-readable recording medium, such as CD-ROM, RAM, ROM, floppy disks, hard disks, magneto-optical disks and so forth. Since this process can be easily implemented by those skilled in the art to which the present invention pertains, further description on it will not be provided herein.

According to the embodiments of the present invention, a plurality of master terminals that belong to a personal use scope may share personal use group information. Therefore, although the used master terminal is a master terminal of another domain of the same personal use scope, it is possible to register terminals by using the same personal use group information.

While the present invention has been described with respect to the specific embodiments, it will be apparent to those skilled in the art that various changes and modifications may be made without departing from the spirit and scope of the invention as defined in the following claims.

What is claimed is:

1. A method for managing a personal use group using a first master terminal to register and manage terminals belonging to a personal use scope, comprising:
requesting a second master terminal that belongs to the personal use scope for personal use group information;
receiving the personal use group information from the second master terminal; and
registering a terminal that belongs to the personal use scope as the personal use group based on the received personal use group information.

2. The method of claim 1, wherein a plurality of master terminals that belong to the personal use scope share the personal use group information, and register a terminal that belongs to the personal use scope based on the personal use group information.

3. The method of claim 1, wherein the personal use group information includes at least identification information of the personal use group and an encryption key shared in the personal use group.

4. The method of claim 1, wherein the terminal registered in the personal use group is allowed to transmit/receive a digital content to/from another terminal registered in the personal use group through the second master terminal.

5. The method of claim 1, further comprising:
forming a security channel between the first master terminal and the second master terminal after said requesting the second master terminal that belongs to the personal use scope for personal use group information.

6. A first master terminal for registering and managing terminals belonging to a personal use scope, comprising:
a storage configured to store personal use group information;
a personal use group information management unit configured to share the personal use group information with a second master terminal; and
a registration unit configured to register a terminal that belongs to the personal use scope in a personal use group based on the personal use group information.

7. The master terminal of claim 6, wherein the personal use group information management unit requests the second master terminal for the personal use group information and receives the personal use group information, or transmits the personal use group information stored in the storage to the second master terminal.

8. The master terminal of claim 6, wherein the personal use group information includes at least identification information of the personal use group and an encryption key shared in the personal use group.

9. The master terminal of claim 6, further comprising:
a digital content restoration unit configured to decrypt and restore an encrypted digital content based on the personal use group information.

10. A personal use group management system for registering and managing a plurality of terminals belonging to a personal use scope, comprising:
a plurality of master terminals configured to share personal use group information, and register the terminals that belong to the personal use scope in a personal use group based on the shared personal use group information; and
the terminals configured to be registered in the personal use group through any one of the master terminals and share a digital content.
